(19) United States
(12) Patent Application Publication
(10) Pub. No.: US 2017/0008381 A1
(43) Pub. Date: Jan. 12, 2017

(54) TWO-PIECE VISOR BLADE WITH REFLECTOR

(71) Applicant: FORD GLOBAL TECHNOLOGIES, LLC, Dearborn, MI (US)

(72) Inventor: David Huelke, Milan, MI (US)

(21) Appl. No.: 14/792,641

(22) Filed: Jul. 7, 2015

(51) Int. Cl. B60J 3/02; B60R 1/12; B60Q 3/02; B60R 7/05

(52) U.S. Cl. CPC B60J 3/0282; B60J 3/026; B60R 7/05; B60R 1/12; B60Q 3/0226; B60R 2001/1269

(57) ABSTRACT

A sun visor for a vehicle includes a visor body comprising adjacent panels hingedly connected at a top edge thereof for translation between an open configuration and a closed configuration and a reflector dimensioned to occupy substantially a length and width dimension of a surface of one of the adjacent panels. The reflector may occupy at least from about 75% to about 95% of the interior surface of the panel. The adjacent panels may be hingedly connected via a friction hinge. Sun visor assemblies including the sun visor body are described.

### TECHNICAL FIELD

This disclosure relates generally to sun visors for motor vehicles. More particularly, the disclosure relates to an improved sun visor blade including adjacent hinged panels configured for translating between an open and a closed configuration, and further including a reflector occupying a significant portion of a surface of one of the adjacent panels.

### BACKGROUND

It is known to provide sun visors for vehicles which can be pivoted into a desired orientation prevent or reduce glare to the vehicle driver and/or passenger's eyes. Prior art designs often are simply a visor panel or blade which the user can pivot by way of a pivoting arm to translate the panel from a first position to a second position depending on whether the majority of the glare is angled through the vehicle windshield or the driver or passenger window. The visor body, which is typically defined by a single panel, can also pivot on an arm between a raised and a lowered orientation.

The visor body can also include various amenities, such as straps and small storage pockets or compartments for holding small items (driver's license, credit cards, vehicle registration, cosmetics, etc.). It is also known to provide a small mirror held in or on the visor body, for the convenience of the driver and/or passenger.

Because of the limited amount of surface area available on the typical sun visor, only mirrors having relatively small surface areas are typically provided, to allow use of the remainder of the limited surface area available for other conveniences as summarized above. Such mirrors have very limited utility due to their small size.

Thus, a need is identified in the art for improvements to sun visor designs. In particular, it would be desirable to provide a sun visor including a larger mirror, to increase the utility and convenience to the user.

### SUMMARY

In accordance with the purposes and benefits described herein and to solve the above-summarized and other problems, in one aspect a sun visor for a vehicle is provided, including a visor body. The visor body is defined by adjacent panels hingedly connected at a top edge thereof and configured for translation between an open configuration and a closed configuration. A reflector is provided, dimensioned to occupy substantially a length and width dimension of a surface area of one of the adjacent panels. In embodiments, the reflector is held in or on an interior surface of the one of the adjacent panels. In embodiments, the reflector is dimensioned to occupy at least from about 75% to about 95% of the interior surface of the one of the adjacent panels. The adjacent panels may be hingedly connected via any suitable hinge structure. In embodiments, the hinged connection is provided by one or more friction hinges.

In embodiments, another of the adjacent panels includes one or more actuable lights. The another of the adjacent panels may also include one or more associated storage compartments or pockets. The visor body may be pivotally connected to a pivoting arm, allowing the sun visor to be displaced between a front-facing orientation (relative to the vehicle) and a side-facing orientation.

In other aspects of the disclosure, assemblies incorporating the sun visor body described above are provided.

In the following description, there are shown and described embodiments of the disclosed sun visor. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed sun visor, and together with the description serve to explain certain principles thereof. In the drawing:

FIG. 1 shows a front perspective view of a sun visor assembly according to the present disclosure, held in an opened configuration; and

FIG. 2 shows a side view of the sun visor assembly of FIG. 1; held in a closed configuration.

Reference will now be made in detail to embodiments of the disclosed sun visor and assemblies incorporating same, examples of which are illustrated in the accompanying drawing figures wherein like reference numerals indicate like features.

### DETAILED DESCRIPTION

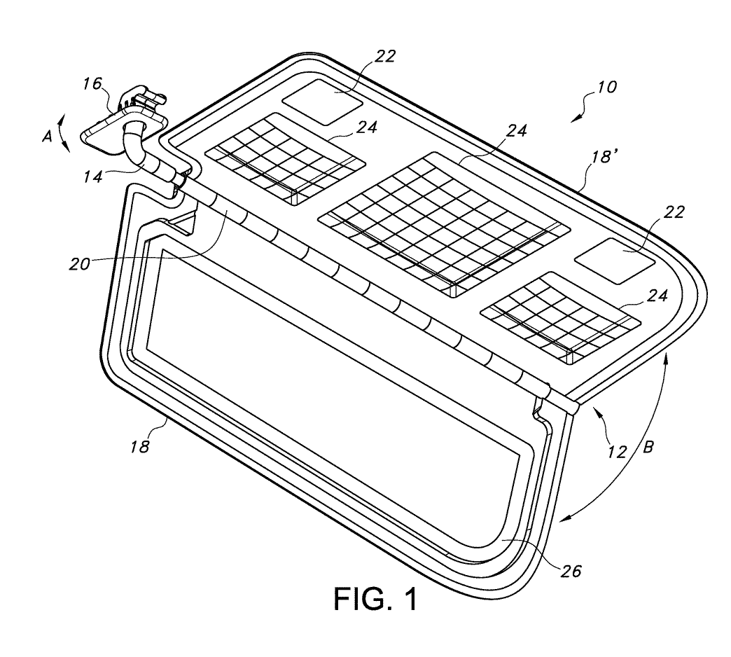

With reference to FIG. 1, a sun visor assembly 10 is provided including a sun visor body 12, a pivoting arm 14, and a vehicle mounting bracket 16. As is known, bracket 16 is configured to allow pivoting of arm 14 (see arrow A) to translate the visor body 12 between a forward-facing orientation to reduce glare passing through a vehicle windshield (not shown) and a side-facing orientation to reduce glare passing through a vehicle side window (not shown).

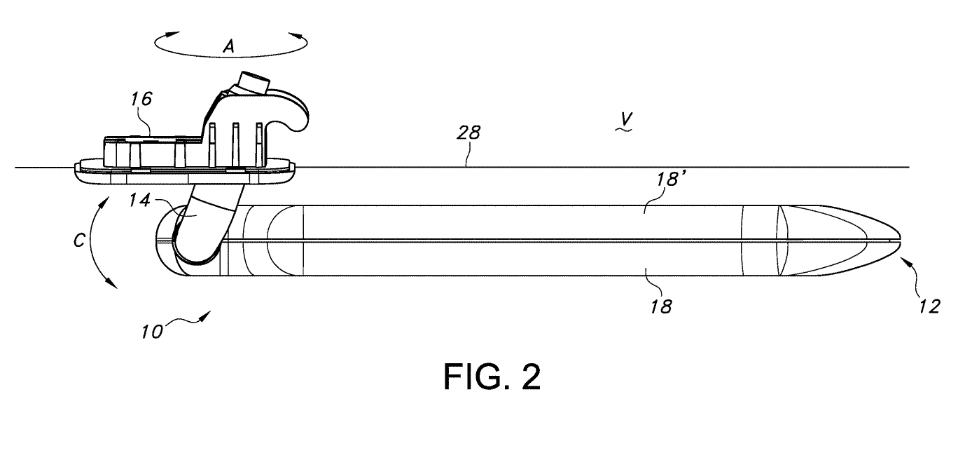

In the depicted embodiment, visor body 12 is defined by a pair of adjacent panels 18, 18′. The panels 18, 18′ are hingedly connected one to another at a top edge thereof via a hinge assembly 20, thus defining a clamshell design configured for translating (see arrow B) between an opened configuration and a closed configuration (see FIG. 2). As is known, hinge assembly 20 also allows pivoting the visor body 12 between a raised orientation substantially coplanar with a roof 28 of a vehicle V, and a lowered or deployed configuration to block glare (see FIG. 2, arrow C).

Hinge assembly 20 may be provided by one or more hinges of any suitable type. In embodiments, a friction-type hinge is provided, allowing the visor body 12 to be retained in the open and/or closed configurations shown in FIGS. 1 and 2. However, any suitable hinge structure is contemplated, including without intending any limitation detent hinges, torque hinges, position hinges, locking hinges, living hinges, and others. Optionally, a catch (not shown) may be provided to secure the visor body 12 in the closed configuration shown in FIG. 2 until a user elects to open the visor body.

A variety of amenities and useful features may be provided in association with one or both of the visor panels 18, 18′. As shown, visor panel 18′ may be provided with one or more actuable lights 22 and also one or more storage compartments or pockets 24, each held on or in a portion of the panel 18′.

In turn, a reflector 26 is provided, held on or in panel 18 of the visor body, and providing a reflective surface for use by a vehicle occupant. As shown, reflector 26 occupies a substantial portion of a length and width dimension of a surface area of the panel 18. In embodiments, reflector 26 occupies at least from about 75% to about 95% of the surface area of the panel 18. This would allow attachment of other peripheral conveniences, for example third party-manufactured universal garage door openers, slide-on rod mechanisms, and the like.

By this feature, it will be appreciated that a much larger reflector is provided than is possible with conventional visor designs, increasing the utility and convenience of the visor assembly 10 to a vehicle occupant. If needed, reflector 26 may be used in conjunction with illumination provided by lights 22, or may be provided with associated illumination disposed in or near its reflective surface (embodiment not shown).

As depicted, the reflector 26 is held on or in an interior surface of panel 18, and thus the reflector will not be visible when the visor body 12 is in the closed configuration (see FIG. 2). Thus, to use the reflector 26, a vehicle occupant need only translate the visor body 12 from the closed configuration of FIG. 2 to the opened configuration of FIG. 1 (see arrow B).

As will be appreciated, by the foregoing description is provided a convenient, low profile sun visor two-piece blade including a variety of lighting and storage amenities, but also a significantly larger reflector surface than is possible in conventional visor designs. Advantageously, the various conveniences are held in an interior of the sun visor body until required for use, thus protecting them from damage and also, by their hidden configuration, reducing the likelihood of driver and/or passenger distraction.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A sun visor for a vehicle, comprising:
a visor body comprising adjacent panels hingedly connected at a top edge thereof for translation between an open configuration and a closed configuration; and
a reflector held in or on an interior surface of the one of the adjacent panels and dimensioned to occupy at least from about 75% to about 95% of the surface area of one of the adjacent panels.

2. (canceled)

3. (canceled)

4. The sun visor of claim 1, wherein the adjacent panels are hingedly connected via a friction hinge.

5. The sun visor of claim 1, wherein another of the adjacent panels includes one or more actuable lights.

6. The sun visor of claim 5, wherein the another of the adjacent panels further includes one or more storage compartments or pockets.

7. The sun visor of claim 1, further wherein the visor body is pivotally connected to a pivoting arm.

8. A vehicle including the sun visor of claim 1.

9. A sun visor assembly for a vehicle, comprising:
a visor body comprising adjacent panels hingedly connected at a top edge thereof for translation between an open configuration and a closed configuration;
a reflector held in or on an interior surface of the one of the adjacent panels and dimensioned to occupy at least from about 75% to about 95% of the interior surface area of one of the adjacent panels; and
a pivoting arm holding the adjacent panels.

10. (canceled)

11. (canceled)

12. The assembly of claim 9, wherein the adjacent panels are hingedly connected via a friction hinge.

13. The assembly of claim 9, wherein another of the adjacent panels includes one or more actuable lights.

14. The assembly of claim 13, wherein the another of the adjacent panels further includes one or more storage compartments or pockets.

15. A vehicle including the assembly of claim 9.

16. A sun visor assembly for a vehicle, comprising:
a visor body comprising adjacent panels hingedly connected at a top edge thereof for translation between an open configuration and a closed configuration;
a reflector dimensioned to occupy at least from about 75% to about 95% of a surface area of one of the adjacent panels; and
a pivoting arm holding the adjacent panels.

17. The assembly of claim 16, wherein the reflector is dimensioned to occupy at least from about 75% to about 95% of an interior surface area of the one of the adjacent panels.

18. The assembly of claim 16, wherein the adjacent panels are hingedly connected via a friction hinge.

19. The assembly of claim 16, wherein another of the adjacent panels includes one or more actuable lights.

20. The assembly of claim 19, wherein the another of the adjacent panels further includes one or more storage compartments or pockets.
